(19) United States
(12) Patent Application Publication
(10) Pub. No.: US 2001/0046840 A1
(43) Pub. Date: Nov. 29, 2001

(54) Apparatus for transmitting and receiving radio signals in a pico-BTS

(76) Inventor: Kyung-Hwan Kim, Kyonggi-do (KR)

Correspondence Address: Robert E. Bushnell, Suite 300, 1522 K Street, N.W., Washington, DC, 20005, US

(21) Appl. No.: 09/802,985

(22) Filed: Mar. 12, 2001

(30) Foreign Application Priority Data
May 24, 2000 (KR) 2000-28157

(51) Int. Cl. H04B 3/36

(52) U.S. Cl. 455/7; 455/11.1

(57) ABSTRACT

Disclosed is an apparatus for transmitting and receiving radio signals in a pico-BTS. The apparatus includes a plurality of antennas for transmitting and receiving the radio signals, installed in predetermined positions; and a plurality of repeaters connected to the associated antennas, for controlling levels of the transmission and reception signals to a predetermined level. Further, the apparatus includes a plurality of bi-directional amplifiers for compensating for a signal loss, installed in predetermined positions between the repeaters.

### CLAIM OF PRIORITY

This application makes reference to, incorporates the same herein, and claims all benefits accruing under 35 U.S.C §119 from an application entitled Apparatus For Transmitting/Receiving Radio Signals In Pico Base Station Transceiver System earlier filed in the Korean Industrial Property Office on May 24, 2000, and there duly assigned Ser. No. 2000-28157 by that Office.

### BACKGROUND OF THE INVENTION

1. Field of the Invention

The present invention relates generally to a pico-BTS (Base station Transceiver System), and in particular, to an apparatus for transmitting and receiving radio signals in a pico-BTS.

2. Description of the Related Art

In general, a mobile communication system provides a communication service by dividing its service area into various cells. The cells are classified into macrocell, microcell and picocell according to the size. In a recent mobile communication system, a cell with a radius of 5-30 Km is called a macrocell, and a cell with a radius reduced to 500 m-1 Km to increase the subscriber capacity is called a microcell. Furthermore, a cell having a size between the sizes of the macrocell and the microcell is called a minicell, and a cell with a small radius of below 200 m is called a picocell. In addition, a low-orbit satellite mobile communication system uses a cell with a radius of over 100 Km, which is called a megacell.

The picocell is typically employed to provide an in-building communication service, and provide a communication service to a limited area such as campus, stadium, airport and shopping mall. Further, the picocell is used to compensate for deterioration of the service quality of the macrocell and the minicell including a topographical obstacle such as a tunnel, and to increase the communication quality in an area with a low communication quality. A communication service of the picocell is provided by a pico-BTS.

Incorporated by reference herein are U.S. Pat. No. 5,991,630 to Philippe Charas entitled Dynamic Channel Allocation For Sectorized Radio Access Units Of A Mobile Communication System wherein the concept of wireless communication in small cellular areas, such as picocells, etc. and the use of microstrip patch antennas is discussed; and U.S. Pat. No. 5,898,683 to Shinji Matsumoto et al. entitled Base Station System Suitable For Microcells which discusses the use of a base station for radio communication over a predetermined frequency suitable for use in a microcell.

### SUMMARY OF THE INVENTION

It is an object of the present invention to provide an apparatus for stabilizing signal levels of the antennas for transmitting and receiving radio signals in a pico-BTS.

It is another object of the present invention to provide a simple and high-efficiency apparatus for transmitting and receiving radio signals to a mobile station in a pico-BTS.

To achieve the above and other objects, there is provided an apparatus for transmitting and receiving radio signals in a pico-BTS. The apparatus includes a plurality of antennas for transmitting and receiving the radio signals, dispersed in predetermined positions; and a plurality of repeaters connected to the associated antennas, for controlling levels of the transmission and reception signals to a predetermined level.

Further, the apparatus includes a plurality of bi-directional amplifiers for compensating for a signal loss, installed in predetermined positions between the repeaters.

Preferably, the antennas each include a microstrip patch antenna included in the associated repeater.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a diagram illustrating an apparatus for transmitting and receiving radio signals in a pico-BTS; and

FIG. 2 is a diagram illustrating an apparatus for transmitting and receiving radio signals in a pico-BTS according to a preferred embodiment of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

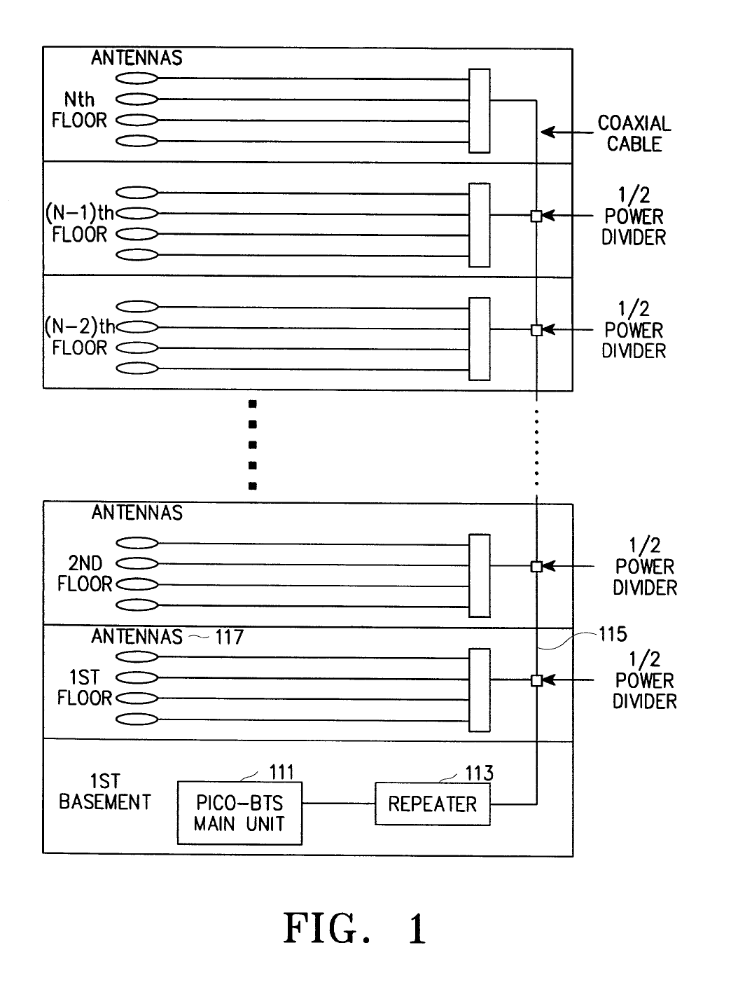

FIG. 1 illustrates an apparatus for transmitting and receiving radio signals in a pico-BTS (Base station Transceiver System). Referring to FIG. 1, if it is assumed that the pico-BTS services an N-story building, a signal generated from a pico-BTS main unit 111 is amplified to a predetermined level by a repeater 113 and then provided to power dividers installed in each floor through a coaxial cable 115. The signals divided by the power dividers are provided to a plurality of antennas 117 dispersed in each floor and transmitted to a mobile station (not shown) in each floor. Meanwhile, the signal from the mobile station is received at the antennas 117 and then provided to the pico-BTS main unit 111 through the power dividers and the repeater 113.

In this structure, the antennas 117 dispersed in each floor have the different signal levels according to the distance from the repeater 113 and the power level divided by the power divider installed in each floor. Particularly, when the pico-BTS employs a 2-frequency assignment (2FA) technique (in which two operating frequencies are used) or a 3-frequency assignment (3FA) technique rather than a 1-frequency assignment (1FA) technique, this structure causes an increase in number of repeaters 113 and antennas 117, thus increasing the complexity and the cost of the pico-BTS.

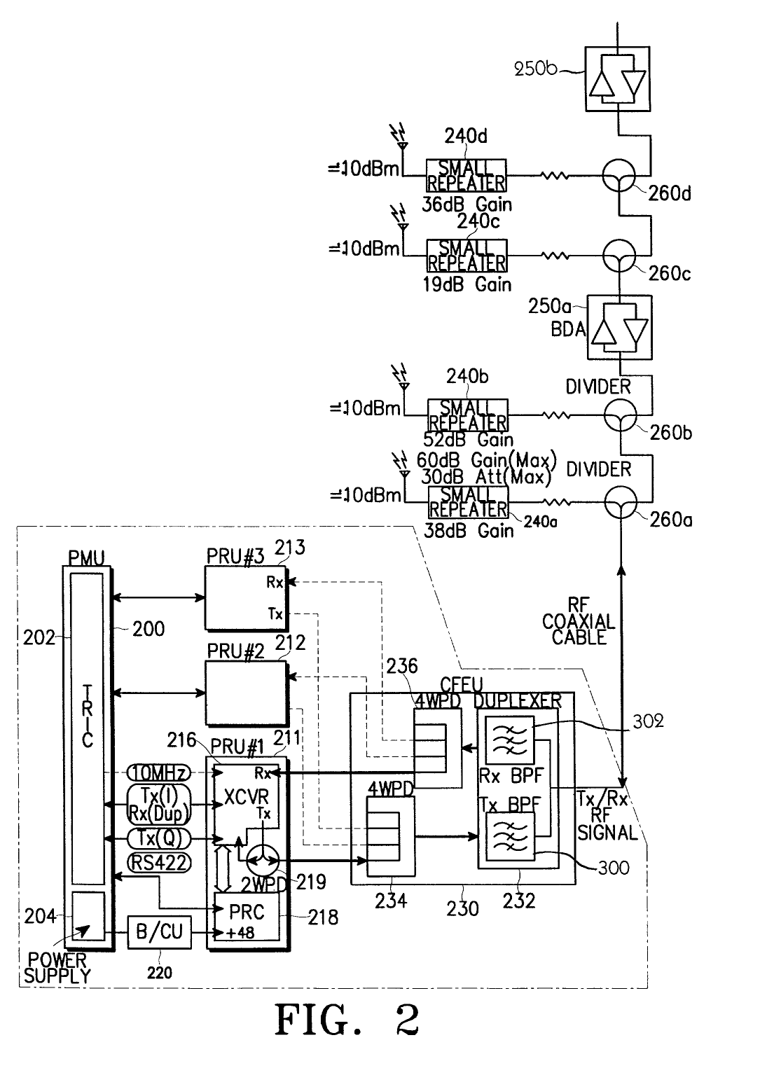

FIG. 2 illustrates an apparatus for transmitting and receiving radio signals in a pico-BTS according to a preferred embodiment of the present invention. The pico-BTS shown in FIG. 2 is applied to a 3FA/OMNI private radio exchange, and includes PMCC (Pico-BTS Main Controller Card; not shown)), PCC (Pico-BTS Channel Card; not shown), PMU (Private BTS Main Unit) 200, and private BTS radio units (PRUs) 211-213. A detailed description of some of the elements of the pico-BTS will be avoided for simplicity, since they have the same structure and operation as that of a general BTS in the public mobile communication system.

Referring to FIG. 2, the PMU 200 has the function of providing 10 MHz clock and baseband I/Q signals to the PRUs 211-213, and the function of receiving a 239 MHz IF (Intermediate Frequency) duplex signal from the PRUs 211-213 and processing the received duplex signal in its internal TRIC (Transmit and Receive Interface Card) 202. The TRIC 202 included in the PMU 200 performs Tx/Rx (transmission/reception) interfacing between the PRUs and the PCC (Pico-BTS Channel Card; not shown). In addition, the PMU 200 includes a power supply 204.

The PRU#1 211, the PRU#2 212 and the PRU#3 213 for FA1 (frequency assignment 1), FA2 (frequency assignment 2) and FA3 (frequency assignment 3) up-convert the baseband I/Q signals to RF (Radio Frequency) transmission signals and down-convert the received RF signals to 239 MHz IF signals. The PRUs 211-213 each include a transceiver (XCVR) 216, a pico-BTS remote unit controller (PRC) 218 and signal divider (or splitter) 219.

A cable front-end unit (CFEU) 230 provided to the apparatus according to the present invention has the function of combining FA1, FA2 and FA3 signals output from the PRUs 211-213 and providing the combined signals to the antennas through dividers and small repeaters in the following stages via a coaxial cable for transmitting a Tx/Rx RF carrier, and the function of distributing the FA1, FA2 and FA3 signals received at each antenna to the corresponding PRUs 221-213.

To this end, the CFEU 230 includes a combiner 234 comprised of a 4-way power divider (4WPD) for combining the FA1, FA2 and FA3 signals provided from transmission ends (Tx) of the PRUs 211-213 via splitter 219, a duplexer 232 for transmitting the signals combined by the combiner 234 to the coaxial cable and filtering the FA1, FA2 and FA3 signals from the signals received through the coaxial cable, and a divider 236 comprised of 4WPD a for distributing the received FA1, FA2 and FA3 signals filtered by the duplexer 232 to receiving ends (Rx) of the corresponding PRUs 211-213. The combiner 234 and the divider 236 each include an extra port (not shown), in addition to the ports for transmitting and receiving the FA1, FA2 and FA3 signals, to monitor through this extra port an operation of the CFEU using a measuring device such as a spectrum analyzer.

Meanwhile, the antennas for transmitting and receiving the radio signals, installed in each floor, are respectively connected to small repeaters 240a-240d for controlling the signal levels of the associated antennas. The small repeaters 240a-240d amplify the power of the final radio transmission signals to a predetermined level, e.g., 10 dBm before transmission, and amplify the received radio signals. To this end, the small repeaters can include an automatic gain controller (AGC; not shown). The antennas can be comprised of a microstrip patch antenna, which is included in the associated small repeater.

The small repeaters 240a-240d are connected to the coaxial cable for transmitting the RF carrier, through power dividers 260a-260d, respectively. A plurality of bi-directional amplifiers (BDAs) 250a and 250b, for compensating a signal loss, are installed in proper positions on the path for connecting the power dividers or the small repeaters.

The FA1, FA2 and FA3 signals output from the PRUs 211-213 are combined by the combiner 234 in the CFEU 230, and radiated through a band-pass filter 300 for transmission signals in the duplexer 232, the dividers 260a-260d, the BDAs 250a-250b and the small repeaters 240a-240d and antennas; and the FA1, FA2 and FA3 signals received from the antennas and small repeaters 240a-240d are distributed to the PRUs 211-213 through the dividers 260a-260d, the BDAs 250a-250b, the band-pass filter 302 for received signals in the duplexer 232 and the divider 236 of the CFEU 230.

As described above, the novel apparatus can stabilize the signal levels of the antennas for transmitting and receiving the radio signals in the pico-BTS, contributing to simplification and high efficiency of the pico-BTS.

While the invention has been shown and described with reference to a certain preferred embodiment thereof, it will be understood by those skilled in the art that various changes in form and details may be made therein without departing from the spirit and scope of the invention as defined by the appended claims. For example, although the invention has been described with reference to the 3FA/OMNI private radio exchange, the same can also be applied to a 2FA or 1FA pico-BTS.

What is claimed is:

1. An apparatus for transmitting and receiving radio signals in a pico-BTS (Base station Transceiver System), comprising:
a plurality of antennas for transmitting and receiving the radio signals, installed in predetermined positions; and
a plurality of repeaters connected to corresponding ones of said antennas, for controlling levels of the transmission and reception signals to a predetermined level.

2. The apparatus as claimed in claim 1, further comprising a plurality of bi-directional amplifiers for compensating for a signal loss, installed in predetermined positions between the repeaters.

3. The apparatus as claimed in claim 1, wherein the antennas each comprise a micro strip patch antenna included in the corresponding repeater.

4. An apparatus for transmitting and receiving radio signals in a pico-BTS (Base station Transceiver System) with at least one operating frequency, comprising:
at least one radio unit for said at least one operating frequency;
a cable front-end unit for combining the operating frequency output from the radio unit, and distributing a received operation frequency to the radio unit;
a plurality of antennas for transmitting and receiving the radio signals, installed in predetermined positions; and
a plurality of repeaters connected to the cable front-end unit through a coaxial cable and a plurality of dividers, said repeaters being also connected to corresponding ones of said antennas to control levels of the transmission and reception signals to a predetermined level.

5. The apparatus as claimed in claim 4, further comprising a plurality of bi-directional amplifiers for compensating for a signal loss, installed in predetermined positions between the repeaters.

6. The apparatus as claimed in claim 4, wherein the antennas each comprise a microstrip patch antenna included in the corresponding repeater.

7. An apparatus for transmitting and receiving radio signals in a pico-BTS (Base station Transceiver System) having three assigned frequencies, comprising:
a plurality of radio unit for transmitting and receiving signals on said three assigned frequencies;
a cable front-end unit for combining transmission signals transmitted on the three assigned frequencies output from the radio units, and dividing a received combination signal to separate reception signals received on the three assigned frequencies for distribution to the radio units;
a plurality of dividers serially distributed along a coaxial cable connected to said cable front-end unit;
a plurality of antennas for transmitting and receiving radio signals, installed in predetermined positions; and
a plurality of repeaters, each being connected between a corresponding one of said plurality of dividers and a corresponding one of said plurality of antennas, to control levels of the transmission and reception signals to a predetermined level.

8. The apparatus as claimed in claim 7, wherein the antennas each comprise a microstrip patch antenna included in the corresponding repeater.

9. The apparatus as claimed in claim 7, further comprising a plurality of bi-directional amplifiers serially installed along said coaxial cable in predetermined positions between certain ones of said dividers for compensating for a signal loss.

10. The apparatus as claimed in claim 7, wherein said a cable front-end unit comprises:
a combiner for combining said transmission signals transmitted on the three assigned frequencies output from the radio units; and
a divider for dividing said received combination signal to separate reception signals received on the three assigned frequencies for distribution to the radio units.

11. The apparatus as claimed in claim 10, wherein said a cable front-end unit further comprises a duplexer, said duplexer comprising:
a first bandpass filter for filtering the transmission signals to be applied to said coaxial cable; and
a second bandpass filter for filtering the reception signals received from said coaxial cable.

12. The apparatus as claimed in claim 11, wherein the antennas each comprise a microstrip patch antenna included in the corresponding repeater.

13. The apparatus as claimed in claim 12, further comprising a plurality of bi-directional amplifiers serially installed along said coaxial cable in predetermined positions between certain ones of said dividers for compensating for a signal loss.
